(19) United States
(12) Patent Application Publication
(10) Pub. No.: US 2005/0131799 A1
(43) Pub. Date: Jun. 16, 2005

(54) Enhanced online auction method apparatus and system

(76) Inventors: Danny Clay, Springville, UT (US); Steven F. McDaniel, Provo, UT (US); Morgan B. Adair, Lindon, UT (US)

Correspondence Address: KUNZLER & ASSOCIATES, 8 EAST BROADWAY, SALT LAKE CITY, UT, 84111, US

(21) Appl. No.: 10/993,330

(22) Filed: Nov. 19, 2004

Related U.S. Application Data
(60) Provisional application No. 60/529,506, filed on Dec. 15, 2003.

(51) Int. Cl. G06F 17/60

(52) U.S. Cl. 705/37

(57) ABSTRACT

An enhanced online auction system facilitates auction buyers listing items wanted for purchase. Users such as traders may use the auction system to search the item-wanted listings, the item-available listings, or both. Item-available listings may be offered for immediate-sale, auction, or best-offer sale. Item-wanted listings may be solicited for immediate-purchase, reverse-auction, or best-offer purchase. Item-available listings and item-wanted listings may be generated by using an existing listing as a template. All sale and purchase offers may incorporate time-dependent pricing. Auction traders may list a product line or set of item-wanted listings in a hierarchical structure. Fulfillment proposals facilitate auction sellers satisfying a set of item-wanted listings from one or more buyers. Item-available listings and item-wanted listings may be linked or cross-linked by auction traders or automatically by auction system processes.

### CROSS-REFERENCES TO RELATED APPLICATIONS

This application claims the benefit of U.S. Provisional Patent Application No. 60/529,506 entitled “ENHANCED ONLINE AUCTION METHOD APPARATUS AND SYSTEM” and filed on Dec. 15, 2003 for Danny Clay, Steven F. McDaniel, and Morgan B. Adair.

### BACKGROUND OF THE INVENTION

1. Field of the Invention

The present invention relates to auctioning items for sale on an internetwork. Specifically, the invention relates to apparatus, methods, and systems for online auction trading.

2. Description of the Related Art

FIG. 1 is a schematic diagram depicting a prior art online auction trading system 100. The prior art online auction trading system 100 includes one or more auction web servers 110, an auction database 115 that may include a plurality of database replicas or partitions 115a and 115b, an internetwork 120, seller workstations 130, seller data stores 135, and buyer workstations 140. The prior art online trading system 100 facilitates sellers of merchandise and services to post items for auction, and buyers to search or browse for items available for sale.

While the online auction trading system 100 enables certain transactions between auction buyers and sellers it does not provide means for buyers to post item-wanted listings, or for sellers to search for items that auction buyers want to purchase. Furthermore, the auction database is organized as a collection of sale items, and does not enable traders to organize sale items and item-wanted listings into a hierarchical structure corresponding to a product line or aggregate item-wanted listings into a set of related fulfillment requests.

FIG. 2 is a block diagram depicting a typical prior art search interface 200. The prior art search interface 200 includes a search dialog 210, search dialog tabs 220, a search keyword text field 230, search parameter interface elements 240, search results interface elements 250, a search initiation interface element 260, a search results page 270, a search options display 280, and a search results listing 290.

The prior art search interface 200 provide a basic user interface for searching an auction database for items that sellers have offered for sale. However, the prior art search interface 200 does not provide for item-wanted listings or facilitate auction sellers searching for item-wanted listings.

Accordingly, what is needed is an enhanced online auction system that expedites auction buyers creating item-wanted listings, facilitates auction sellers searching item-wanted listings, and enables auction traders to organize sale items and item-wanted listings into a hierarchical structure and aggregate multiple item-wanted listings into an aggregate fulfillment request.

### BRIEF SUMMARY OF THE INVENTION

The present invention has been developed in response to the present state of the art, and in particular, in response to the problems and needs in the art that have not yet been fully solved by currently available online auction systems. Accordingly, the present invention has been developed to provide an improved online auction apparatus, method, and system that overcome many or all of the above-discussed shortcomings in the art.

In one aspect of the present invention, a system for facilitating online commerce facilitates posting items wanted for purchase in addition to items offered for sale. Items offered for sale may be auction items, immediate-sale items, or best-offer items. Items wanted for purchase may be immediate-purchase items, reverse-auction items, or best-offer items. In one embodiment, all sale and purchase offers may incorporate time-dependent pricing.

In another aspect of the present invention, a method for facilitating online commerce facilitates traders using an auction system to search for item-wanted listings, item-available listings, or both. Item-available listings or item-wanted listings may be posted by using an existing auction listing as a template.

In another aspect of the present invention, a method for facilitating marketing of a product line facilitates organizing product line listings into a hierarchical structure. In certain embodiments, users may post item-wanted listings within the hierarchical structure. For example, a user may post an item-wanted listing within a seller's product line for an item that is not in stock, or for an item which the user wishes the seller to begin offering for sale.

In another aspect of the present invention, a method for facilitating purchase fulfillment enables auction traders organize groups of item-wanted listings in a hierarchical structure. Fulfillment proposals facilitate auction sellers satisfying a set of item-wanted listings for one or more auction buyers.

In another aspect of the present invention, a method for linking listings facilitates linking or cross-linking item-available listings and item-wanted listings either manually by auction traders or automatically by auction system processes.

The present invention facilitates a variety of sale and purchase models for auction traders including but not limited to: buyers and sellers of individual items, manufacturers and sellers of a product line, system integrators, and commodity traders. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a typical prior art system for conducting an online auction;

FIG. 2 is a block diagram illustrating a typical prior art search interface for entering auction search parameters and displaying search results;

FIGS. 3, 3A, and 3B are block diagrams illustrating several embodiments of an enhanced search interface of the present invention;

FIG. 4 is a flow chart diagram illustrating one embodiment of an enhanced search method of the present invention;

FIG. 5 is a flow chart diagram illustrating one embodiment of a user interface method of the present invention;

FIG. 6 is a flow chart diagram illustrating one embodiment of a customer request method of the present invention;

FIG. 7 is a flow chart diagram illustrating one embodiment of a proposal fulfillment method of the present invention;

FIG. 8 is a flow chart diagram illustrating one embodiment of an item-wanted search method of the present invention;

FIG. 8A is a flow chart diagram illustrating one embodiment of an auction item search method of the present invention;

FIG. 9 is a flow chart diagram illustrating one embodiment of an item-wanted solicitation method of the present invention;

FIG. 10 is a flow chart diagram illustrating one embodiment of an item-available solicitation method of the present invention;

FIG. 11 is a flow chart diagram illustrating one embodiment of an item-available to item-wanted link method of the present invention; and

FIG. 12 is a flow chart diagram illustrating one embodiment of an item-wanted to item-available link method of the present invention.

FIG. 13 is a block diagram illustrating one embodiment of an item-wanted listing dialog apparatus of the present invention.

### DETAILED DESCRIPTION OF THE INVENTION

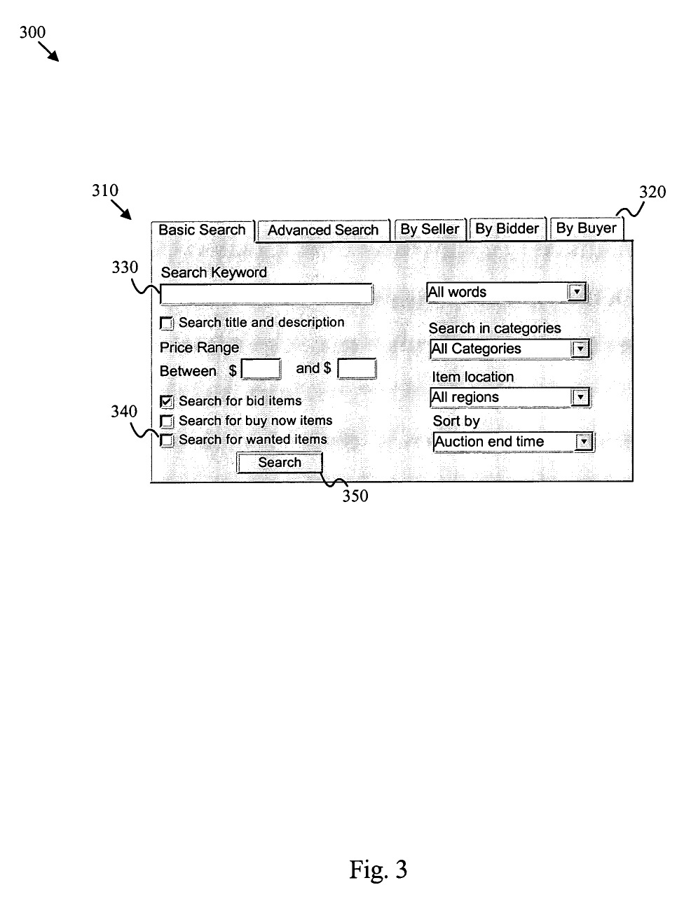

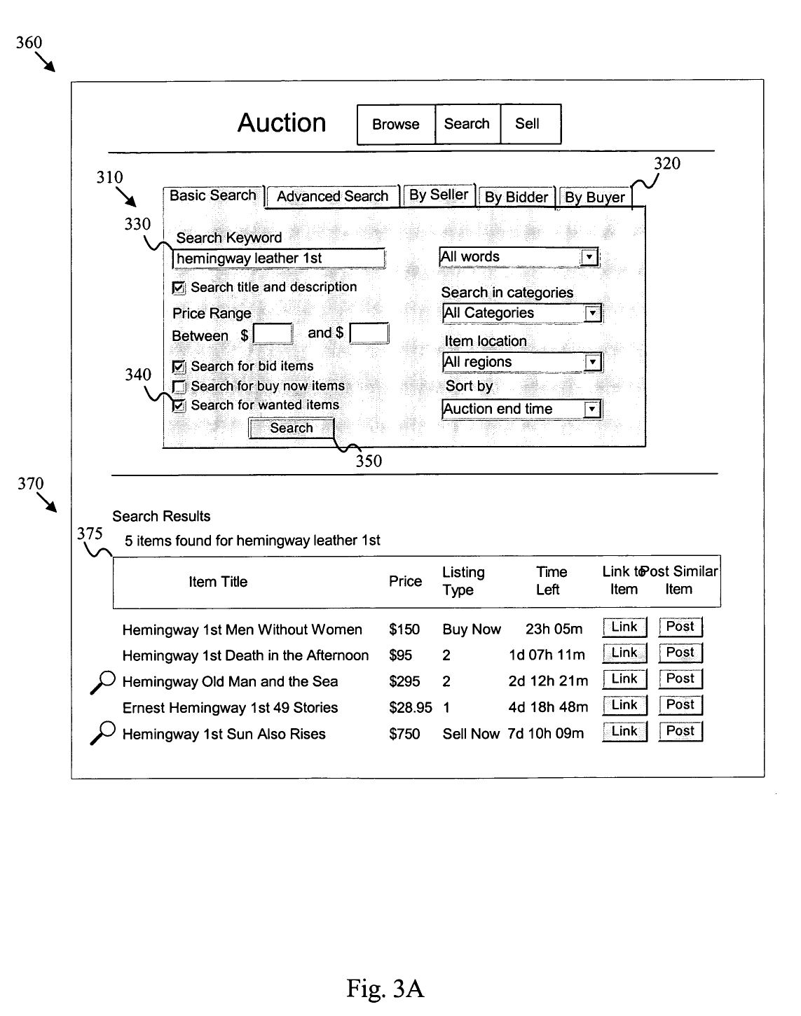

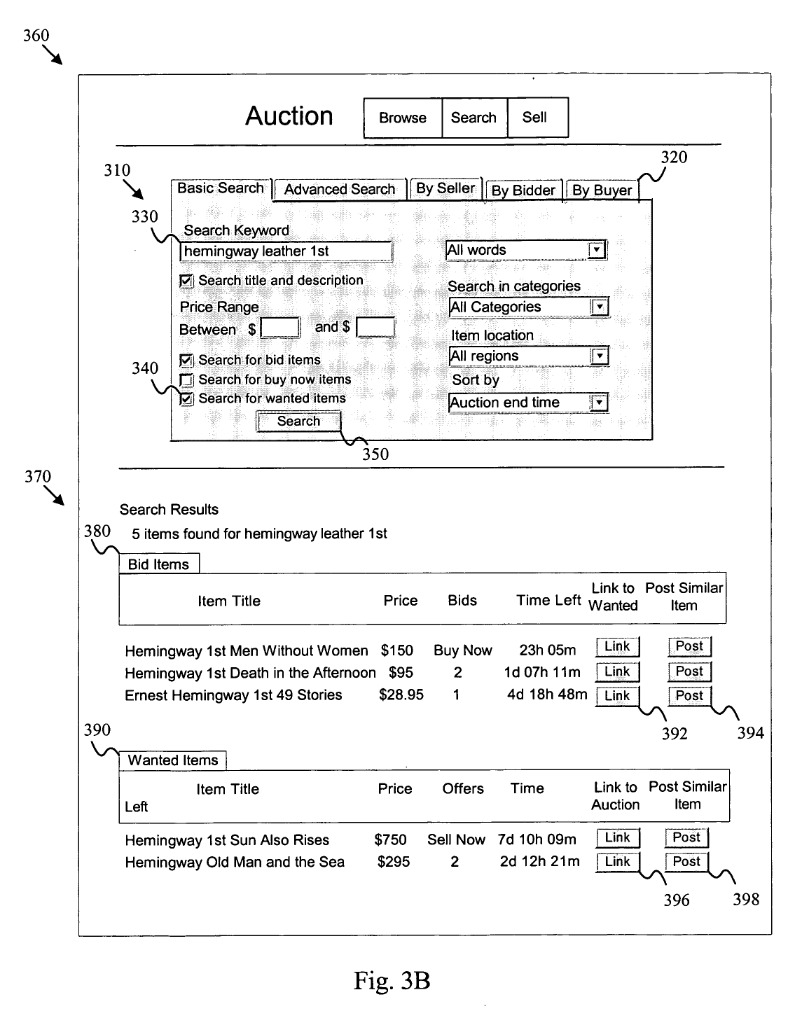

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 3 through 13, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics maybe combined in any suitable manner in one or more embodiments

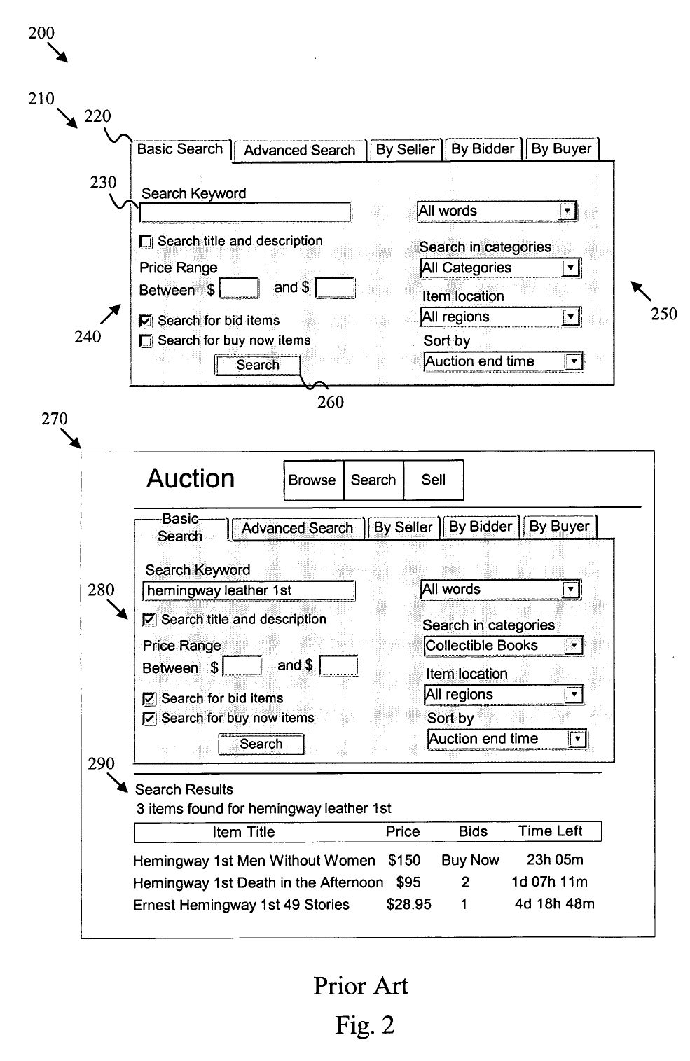

FIG. 3 is a block diagram illustrating one embodiment of a search interface 300 of the present invention. The depicted search interface 300 includes a search dialog 310, a search ‘By Buyer’ tab 320, a search keyword text field 330, a search for wanted items checkbox 340, and a search control 350. The search interface 300 provides enhanced auction features to auction buyers and sellers beyond those provided by the prior art search dialog 210 shown in FIG. 2.

The depicted search dialog 310 may contain all of the search dialog components of the prior art search dialog 210. The depicted search dialog 310 facilitates a user searching the auction database 115 for item-wanted listings by entering keywords into the search keyword text field 330, checking the search for wanted items checkbox 340, and clicking the search control 350. The search ‘By Buyer’ tab 320 facilitates searching the auction database 115 for item-wanted listings by entering the user name or identification number of the buyer who posted the item-wanted listing.

In the depicted embodiment, a search for a wanted-item listing is performed by checking the search for wanted items checkbox 340. In certain embodiments, item-wanted listings may be identified in the auction database 115 by a unique sequence of characters in the item description. For example, item-wanted listing descriptions may begin with the characters “*ISO” to identify the listing as an item the potential buyer is “in search of.”

By facilitating searches for item-wanted listings, the search interface 300 expedites transactions between auction sellers and potential buyers. Auction sellers may search item-wanted listings to measure demand for items the seller may offer for sale, to estimate the market price of wanted items, to identify new products the seller may be able to sell profitably, to identify product features desired by potential purchasers, or to identify potential purchasers that may be contacted when a wanted item is listed for sale.

FIGS. 3A and 3B are text-based diagrams depicting two alternate embodiments of an auction search and search results web page 360a and 360b of the present invention. The auction search and search results web page 360 may include all of the components of the auction search page 300. In addition, the search results web page 360 may include a search results listing 370, an auction items list 380, a wanted items list 390, one or more ‘link to wanted item’ controls 392, one or more ‘post similar auction item’ controls 394, one or more ‘link to auction item’ controls 396, and one or more ‘post similar wanted item’ controls 398.

The search results listing 370 displays a list of items found in a search of the auction database 115. The search results listing 370 may include auction items and wanted items, as specified by search parameters entered in the search dialog 310 by the auction trader.

The auction items list 380 contains a list of auction items returned by a search of the auction database 115. The auction items list 380 may include fields such as the auction item title, the current bid price, if any, the number of bids, and the time remaining in the auction. In the depicted embodiment, the ‘link to wanted item’ controls 392 and the ‘post similar auction item’ controls 394 are associated with each item in the auction items list 380. The ‘link to wanted item’ controls 392 facilitate the auction trader establishing a link in the auction database 115 between an auction item and a similar wanted item listing. The ‘link to wanted item’ controls 392 may also appear on a display containing a detailed description of an auction listing. The ‘post similar auction item’ controls 394 facilitate an auction trader listing an auction item listing based on an existing auction item listing that was returned by a search of the auction database 115. Listing an auction item based on an existing listing facilitates an auction trader listing items for sale without having to enter data for all fields describing the item.

The wanted items list 390 contains a list of wanted items returned by a search of the auction database 115. The wanted items list 390 may include fields such as the auction item title, the current offering price, if any, the number of offers, and the time remaining in the auction. In the embodiment depicted, a ‘link to auction item’ control 396 and a ‘post similar wanted item’ control 398 is associated with each item in the wanted items list 390. The ‘link to auction item’ control 396 facilitates the auction trader establishing a link in the auction database 115 between an item-wanted listing and a similar auction item listing. The ‘link to auction item’ control 396 may also appear on a display containing a detailed description of an item-wanted listing. The post similar wanted item controls 398 facilitates listing an item-wanted listing based on an existing item-wanted listing that was returned by a search of the auction database 115. Listing an item-wanted listing based on an existing listing facilitates creating an item-wanted listing without entering data in all fields describing the item.

In some embodiments, the wanted items list 390 may identify the potential buyer listing the item-wanted listing. In other embodiments, the wanted items list 390 may display item-wanted listings anonymously. Anonymous display of items-wanted listings promotes communication of potential buyer demand to auction sellers without providing a means for contact between auction sellers and potential buyers outside the auction system. In this way, anonymous display of items-wanted listings helps protect the profitability of the auction system. In some embodiments, the wanted items list 390 may include a mechanism for allowing auction sellers to notify anonymous creators of item-wanted listings when an item possibly matching an item-wanted listing is listed for sale.

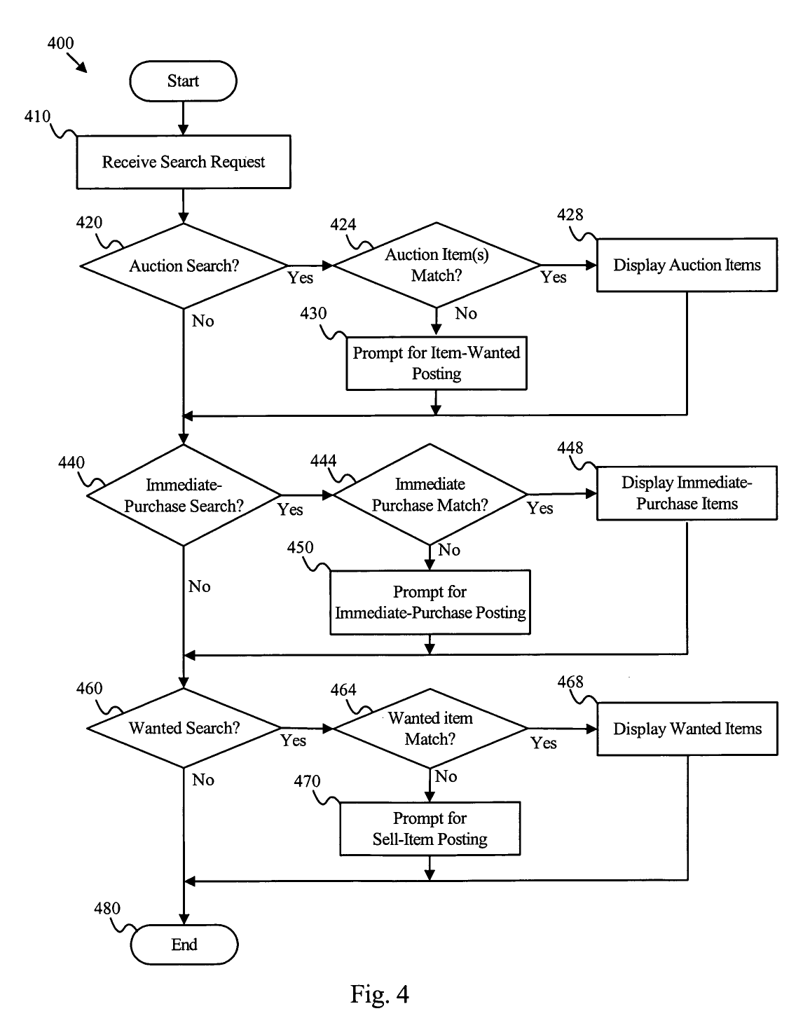

FIG. 4 is a flow chart diagram illustrating one embodiment of an enhanced auction search method 400 of the present invention. The depicted enhanced auction search method 400 includes processing branches 415, 435, and 455 that respectively correspond to searching for auction items, searching for immediate-purchase items, and searching for wanted items. In certain embodiments, the enhanced auction search method 400 prompts a user with an option to post a listing if no listings are found that match the search criteria provided by the user.

The depicted method begins by receiving 410 a request to conduct a search. In one embodiment, receiving 410 a request to conduct a search corresponds to a user filling out a search dialog such as the search dialog 310 depicted in FIG. 3. In response to receiving 410 the search request, the depicted method 400 proceeds sequentially or concurrently through the processing branches 415, 435, and 455.

The processing branch 415 relates to searching for auction items and begins by testing 420 whether the search as specified by the user includes searching for auction items. If the specified search does not include searching auction items, the processing branch 415 is aborted. If the specified search includes searching for auction items the method proceeds by testing 424 whether the database contains one or more auction items that match the search criteria.

If the one or more auction items that match the search criteria are found, the ° O B method 400 continues by displaying 428 a listing of the auction items to the user. However, if no auction items are found that match the search criteria, the method continues by prompting 450 the user with an option to create an item-wanted listing. In one embodiment, prompting 450 includes displaying a pop-up dialog. In another embodiment, prompting includes displaying a link to a listing page.

In the depicted embodiment, the processing branch related to immediate-purchase items includes an immediate-purchase search test 440, an immediate-purchase match test 444, a display immediate-purchase items step 448, and a prompt for immediate-purchase listing step 450.

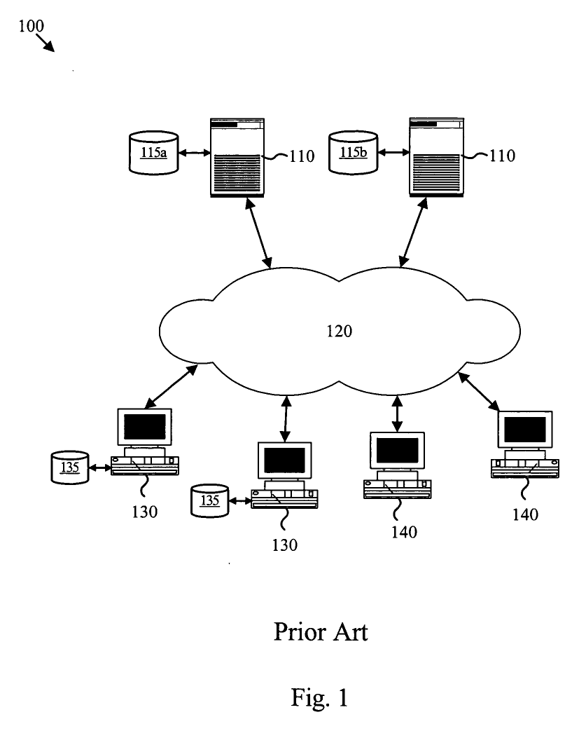

In the depicted embodiment, the processing branch related to wanted items includes a wanted items search test 460, a wanted item match test 464, a display wanted items step 468, and a prompt for sell-item listing 470. The enhanced auction search method 400 is used in accordance with the auction search and search results pages 300 shown in FIG. 3, and the auction database 115 shown in FIG. 1. The enhanced auction search method 400, in addition to the search capabilities provided in prior art, facilitates searching the auction for wanted items that have been posted by auction buyers.

The receive request step 410 receives a request to search the auction database 115 from an auction trader utilizing the search dialog 310 or the like. The auction web server 210 receives search parameters entered by the auction trader and initiates a search of the auction database 115.

The auction items requested test 420, determines whether the auction trader is searching the auction database 115 for items posted for auction. If the trader is searching for auction items, the auction search method 400 continues with matching auction items test 424, otherwise the auction search method 400 continues with the immediate-purchase items requested test 440.

The matching auction items test 424, determines whether the auction database 115 contains auction items matching the parameters received from the auction trader in the receive search request step 410. If there are matching items, the auction search method 400 continues with the display auction items step 428, otherwise the auction search method 400 continues with the display items wanted element step 430.

The display auction items step 428 displays the results of the matching auction items test 424 using the search results listing 370. The items may be displayed in chronological order by the date and time they were posted, in chronological order by the auction end date and time, in numerical order by current bid, or in reverse numerical order by current bid. The display order and the auction item data fields displayed maybe configurable by the auction trader.

The display auction items wanted element step 430 provides an auction trader with the option of listing an auction item-wanted listing by displaying a user interface element such as a control, dialog, icon, hyperlink, or the like. The item-wanted element may be linked to a data entry page, a form, a dialog, a wizard, or the like.

The immediate-purchase items requested test 440 determines whether the auction trader has initiated a search for items available for immediate-purchase. If the trader is searching for immediate-purchase items, the auction search method 400 continues with the matching immediate-purchase items test 444, otherwise the auction search method 400 continues with the wanted items requested test 460.

The matching immediate-purchase items test 444 determines whether the auction database 115 contains immediate-purchase items matching the parameters received from the auction trader in the receive search request step 410. If there are matching items, the auction search method 400 continues with the display immediate-purchase items step 448, otherwise the auction search method 400 continues with the display items wanted element step 450.

The display immediate-purchase items step 448 displays the results of the matching immediate-purchase items test 444 using the search results listing 370. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display immediate-purchase items wanted element step 450 provides an auction trader with the option of listing an immediate-purchase item-wanted listing by displaying a user interface element such as a control, dialog, icon, hyperlink, or the like. The item-wanted element may be linked to a data entry page, a form, a dialog, a wizard, or the like.

The wanted items requested test 460 determines whether the auction trader has initiated a search for wanted items. If the trader is searching for wanted items, the auction search method 400 continues with the matching wanted items test 464, otherwise the auction search method ends 480.

The matching wanted items test 464 determines whether the auction database 115 contains wanted items matching the parameters received from the auction trader in the receive search request step 410. If there are matching items, the auction search method 400 continues with the display wanted items step 468, otherwise the auction search method 400 continues with the display sell item element step 470.

The display wanted items step 468 displays the results of the matching wanted items test 464 using the search results listing 370. The items may be displayed in chronological order by the date and time they were posted, in chronological order by the auction end date and time, in numerical order by current bid, or in reverse numerical order by current bid. The display order and the auction item data fields displayed maybe configurable by the auction trader.

The display sell item element step 470 provides an auction trader with the option of listing a new item listing for an auction or immediate-sale item by displaying a user interface element such as a control, dialog, icon, hyperlink, or the like. The item-wanted element may be linked to a data entry page, form, a dialog, a wizard, or the like.

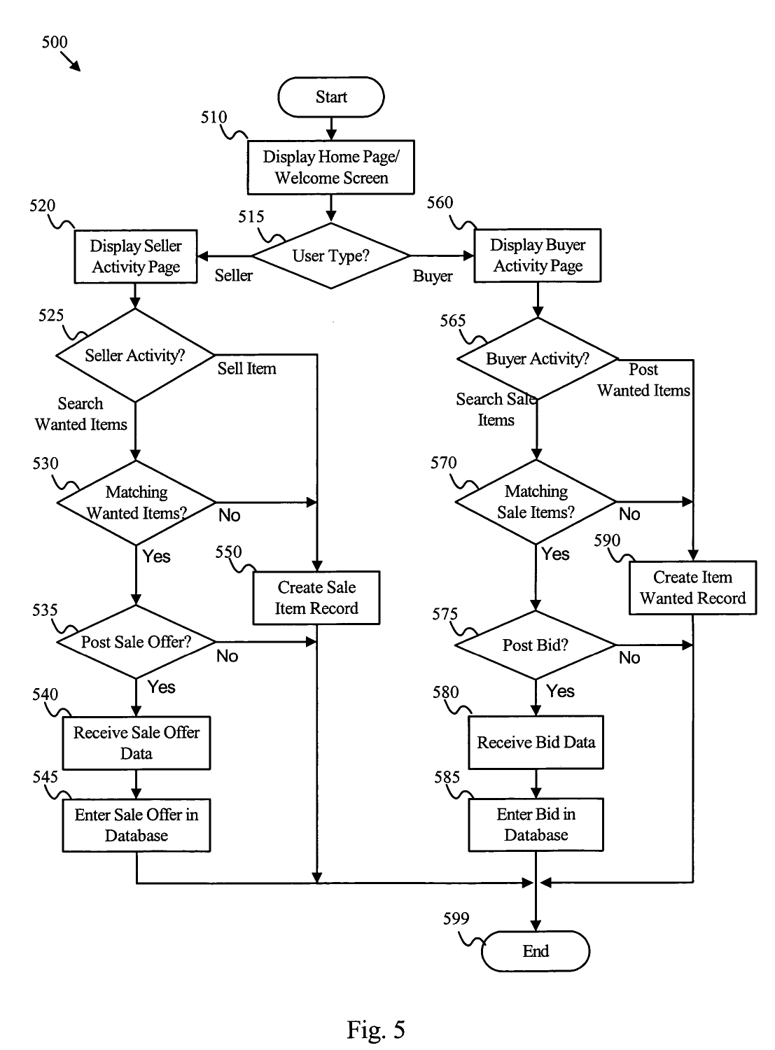

FIG. 5 is a flow chart diagram illustrating one embodiment of a user interface method 500 of the present invention. The user interface method 500 includes a display home page step 510, a user type test 515, a display seller page step 520, a seller activity test 525, a matching wanted items test 530, a post sale offer test 535, a receive offer data step 540, an enter offer in database step 545, a create sale item record step 550, a display buyer page step 560, a buyer activity test 565, a matching sale items test 570, a post bid test 575, a receive bid data step 580, an enter bid data in database step 585, and a create item-wanted record step 590. The user interface method 500 obtains database search parameters from auction traders, presents results of database searches, provides auction traders with the option to create new sale item and item-wanted listings, and provides auction traders with the option to post sale offers and bids.

The display home page step 510 provides user interface elements that introduce auction traders to the highest level operations of the auction system. Operations may be accessed using user interface elements such as menus, tabs, lists, icons, or the like. The display home page step 510 typically provides basic instructions to auction traders in the use of the auction system and links to detailed instructions, frequently asked questions about the auction system, an auction trader registration page, an auction trader login page, and the like.

The user type test 515 determines whether the auction trader accessing the auction system is operating as a buyer or seller. If the auction trader is acting as a seller, the user interface method 500 continues with the display seller activity page step 520. If the auction trader is acting as a buyer, the user interface method 500 continues with the display buyer activity page step 560. Auction traders may act in either role at various times, and in some embodiments the user interface method 500 provides operations associated with both roles to all auction traders.

The display seller page step 520 provides user interface elements that facilitate auction sellers selling items using the auction system and search the auction database 115 for wanted item records. In some embodiments, the display seller page step 520 includes registering the auction trader or logging the auction trader into the auction system.

The seller activity test 525 determines whether the auction seller is searching the auction database 115 for wanted item records or selling items. If the auction seller is searching the auction database 115 for wanted item records, the user interface method 500 continues with the matching wanted items test 530. If the auction seller is selling items, the user interface method 500 continues with the create sale item record step 550.

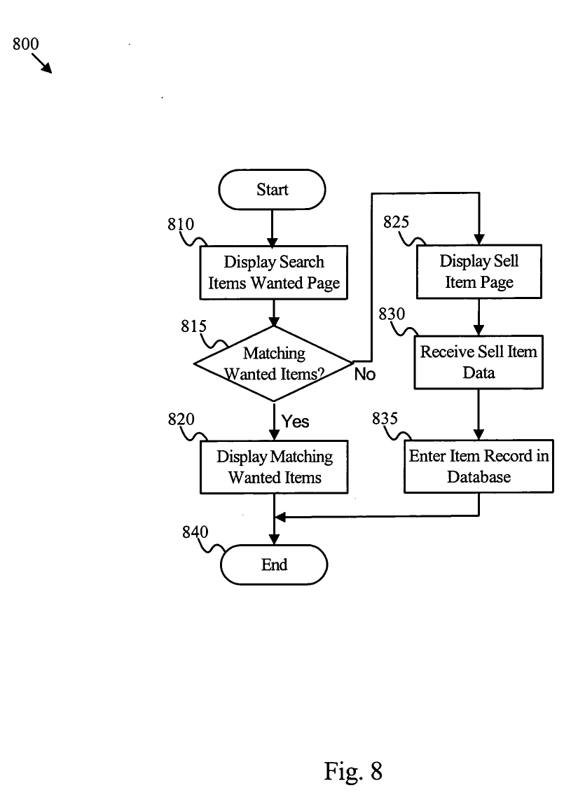

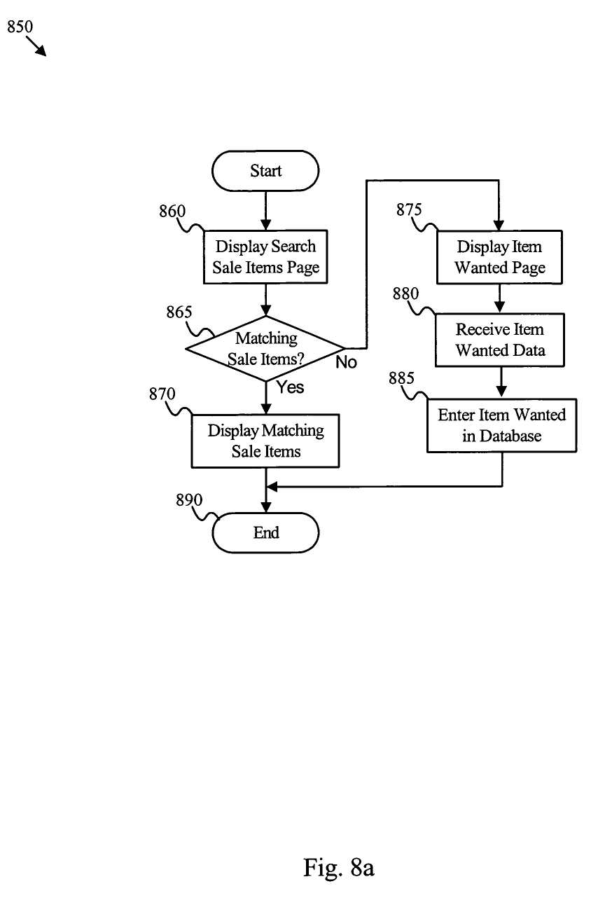

The matching wanted items test 530 obtains search parameters from the auction seller, searches the auction database 115 for records matching the search parameters, and presents the search results to the auction seller. Search results may be presented as a list of wanted item titles with links to pages with a detailed display of data associated with the wanted item. FIG. 8 is a flow chart diagram with the steps of an embodiment of the matching wanted items test 530 and create sale item record step 550 in greater detail. If the auction database 115 contains records that match the search parameters entered by the auction seller, the user interface method 500 continues with the post sale offer test 535, otherwise the user interface method 500 continues with the create sale item record 550.

The post sale offer test 535 determines whether the auction seller wants to post a sale offer for one of the wanted item records displayed by the matching wanted items test 530. If the auction seller wants to post a sale offer, the user interface method 500 continues with the receive sale offer data step 540, otherwise the user interface method 500 ends 599.

The receive offer data step 540 obtains data from the auction seller concerning the offer to be made for a wanted item. In some embodiments, the receive offer data step 540 is initiated by the auction seller selecting a user interface element such as an icon, a control, a menu item, or the like. In some embodiments, the receive offer data step 540 includes registering the auction trader or logging the auction trader into the auction system. The receive offer data step 540 may ask the auction seller to verify the accuracy of data entered. The receive offer data step 540 may obtain offer data using a data entry page, a form, a dialog, a wizard, or the like.

The enter offer in database step 545 records the sale offer entered by the auction seller into the auction database 115. The enter offer in database step 545 may generate an email message to notify the auction buyer who created the wanted item record that an offer has been made on the wanted item. The enter offer in database step 545 may generate an email message to notify the auction seller that a sale offer has been entered into the auction database 115 using the auction seller's account. When the enter sale offer in database step 545 is completed, the user interface method 500 ends 599.

The create sale item record step 550 obtains data from an auction seller concerning an item to be offered for sale in the auction system. FIG. 8 is a flow chart diagram with the steps of an embodiment of the matching wanted items test 530 and create sale item record step 550 in greater detail. The create sale item record step 550 may be initiated by the auction seller selecting a user interface element such as a control, dialog, icon, hyperlink, or the like, or the create sale item record step 550 may be initiated when the matching wanted items test 530 does not return any wanted item records matching the search parameters entered by the auction seller. The create sale item record step 550 may obtain data using a data entry page, a form, a dialog, a wizard, or the like. When the create sale item record step 550 is completed, the user interface method 500 ends 599.

The display buyer page step 560 provides user interface elements that facilitate auction buyers searching the auction database 115 for sale item records and creating item-wanted records in the auction database 115. In some embodiments, the display buyer page step 560 includes registering the auction trader or logging the auction trader into the auction system.

The buyer activity test 565 determines whether the auction buyer is searching the auction database 115 for sale item records or listing wanted items. If the auction buyer is searching the auction database 115 for sale item records, the user interface method 500 continues with the matching sale items test 570; if the auction buyer is listing wanted items, the user interface method 500 continues with the create wanted item record step 590.

The matching sale items test 570 obtains search parameters from the auction buyer, searches the auction database 115 for records matching the search parameters, and presents the search results to the auction buyer. Search results may be presented as a list of sale item titles with links to pages with a detailed display of data associated with the sale item. FIG. 8a is a flow chart diagram with the steps of an embodiment of the matching sale items test 570 and create sale item record step 590 in greater detail. If the auction database 115 contains records that match the search parameters entered by the auction buyer, the user interface method 500 continues with the post bid test 575, otherwise the user interface method 500 continues with the create item-wanted record 590.

The post bid test 575 determines whether the auction buyer wants to post a bid for one of the sale item records displayed by the matching sale items test 570. If the auction buyer wants to post a bid, the user interface method 500 continues with the receive bid data step 580, otherwise the user interface method 500 ends 599.

The receive bid data step 580 obtains data from the auction buyer concerning the bid to be made for a sale item. In some embodiments, the receive bid data step 580 is initiated by the auction buyer selecting a user interface element such as an icon, a control, a menu item, or the like. In some embodiments, the receive bid data step 580 includes registering the auction trader or logging the auction trader into the auction system. The receive bid data step 580 may ask the auction buyer to verify the accuracy of data entered. The receive bid data step 580 may validate the data entered by the auction buyer by assuring that the bid entered exceeds the current bid by a required amount. The receive offer data step 540 may obtain offer data using a data entry page, a form, a dialog, a wizard, or the like.

The enter bid data in database step 585 records the bid entered by the auction seller into the auction database 115. The enter bid in database step 585 may generate an email message to notify the auction seller who created the sale item record that a bid has been made on the sale item. The enter bid in database step 585 may generate an email message to notify the auction buyer that a bid has been entered into the auction database 115 using the auction buyer's account. When the enter bid in database step 585 is completed, the user interface method 500 ends 599.

The create item-wanted record step 590 obtains data from an auction buyer concerning an item-wanted to be purchased through the auction system. FIG. 8a is a flow chart diagram with the steps of an embodiment of the matching sale items test 570 and create item-wanted record step 590 in greater detail. The create item-wanted record step 590 maybe initiated by the auction buyer selecting a user interface element such as a control, dialog, icon, hyperlink, or the like, or the create item-wanted record step 590 may be initiated when the matching sale items test 570 does not return any sale item records matching the search parameters entered by the auction buyer. The create wanted item record step 590 may obtain data using a data entry page, a form, a dialog, a wizard, or the like. When the create item-wanted record step 590 is completed, the user interface method 500 ends 599.

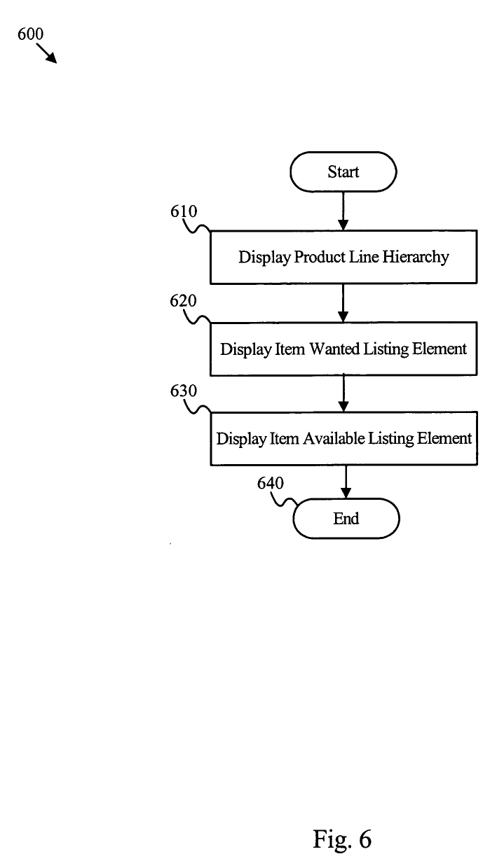

FIG. 6 is a flow chart diagram illustrating one embodiment of a customer request method 600 of the present invention. The customer request method 600 includes a display product hierarchy step 610, a display item-wanted element step 620, and a display item available element step 630. The customer request method 600 facilitates an auction buyer creating an item-wanted record in the auction database 115 that identifies a product in an auction seller's product line that the auction buyer wants to purchase, or requesting a new product to be added to the auction seller's product line. The customer request method 600 also facilitates an auction seller creating a sale item record in the auction database 115 that offers a new or used item in an auction seller's product line for purchase by other auction traders.

The display product hierarchy step 610 displays products in an auction seller's product line. Products may be displayed using user interface elements such as icons, text strings containing product names, tree components, or the like.

The display item-wanted element step 620 displays a user interface element that facilitates an auction buyer creating an item-wanted record in the auction database 115. The user interface element may be linked to a data entry page, a form, a dialog, a wizard, or the like. The item-wanted record may correspond to an existing product in the auction seller's product line hierarchy that is not available for sale, for example, if the product is not in stock by the auction seller. The item-wanted record may also correspond to a product that does not yet exist in the auction seller's product line, which the auction buyer is requesting to be added to the product line.

The display item available element step 630 displays a user interface element that facilitates an auction seller creating a sale item record in the auction database 1 1 5. The user interface element may be linked to a data entry page, a form, a dialog, a wizard, or the like. The sale item record may correspond to a new or used product from the product line hierarchy that the auction seller is offering for auction or immediate-sale.

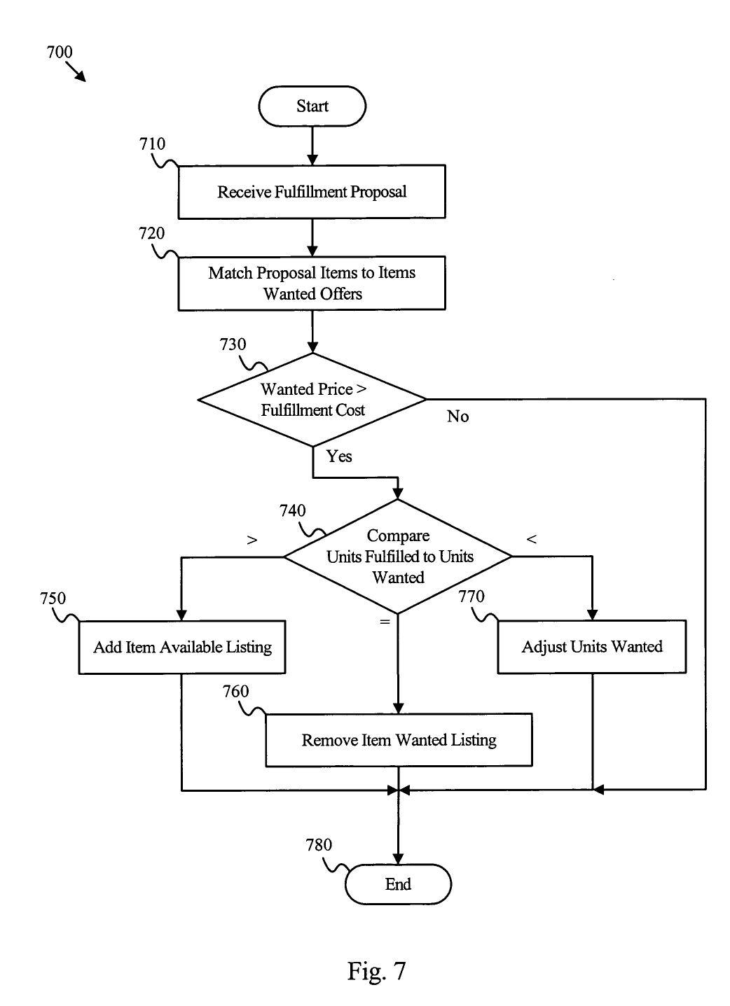

FIG. 7 is a flow chart diagram illustrating one embodiment of a proposal fulfillment method 700 of the present invention. The proposal fulfillment method 700 includes a receive proposal step 710, a match proposal items to offers step 720, a price greater than cost test 730, a compare fulfilled to wanted test 740, an add item available step 750, a remove item-wanted step 760, and an adjust units wanted step 770. The proposal fulfillment method 700 facilitates an auction buyer purchasing a plurality of related items at or below a specified price.

The receive proposal step 710 receives a fulfillment proposal from an auction seller. A fulfillment proposal is type of sale offer wherein a number of identical items or numbers of related items are offered for sale at prices specified by the auction seller.

The match proposal items to offers step 720 matches items in a fulfillment proposal to items wanted offers posted by the auction seller. The match proposal items to offers step 720 may use specifications provided by the auction buyer to enumerate a set of product features or tolerances that will/be accepted in fulfilling the auction buyer's item-wanted listings.

The price greater than cost test 730 determines whether the prices in the auction buyer's item-wanted offers are greater than the item costs in the fulfillment proposal. If the prices in the items wanted offers are greater than the item costs in the fulfillment proposal, the proposal fulfillment method 700 continues with the compare fulfilled to wanted test 740, otherwise the proposal fulfillment method 700 ends 780.

The compare fulfilled to wanted test 740 compares the number of units of each item in the fulfillment proposal with the number of units of each item in the auction buyer's items wanted offers. The compare fulfilled to wanted test 740 may use rules provided by the auction buyer to determine when a number of units of various items will be accepted for purchase. For example, an auction buyer may specify that up to 1000 computer CPUs will be purchased, but only if the fulfillment proposal includes a number of computer monitors equal to the number of CPUs. If the number of units fulfilled is greater than the number of units wanted, the proposal fulfillment method 700 continues with the add item available listing step 750. If the number of units fulfilled is equal to the number of units wanted, the proposal fulfillment method 700 continues with the remove item-wanted listing 760. If the number of units fulfilled is less than the number of units wanted, the proposal fulfillment method 700 continues with the adjust units wanted step 770.

The add item available step 750 removes an item-wanted listing and creates a sale item listing in the auction database 115 for one of the items in the fulfillment proposal. The add item available step 750 only executes when the auction buyer agrees to purchase more than the number of units wanted of one or more items in a set of item-wanted offers. For example, an auction buyer may have an item-wanted listing for 1000 computer CPUs, but agrees that up to 1200 CPUs will be purchased if a fulfillment proposal includes computer monitors for each CPU.

The remove item-wanted step 760 removes an item-wanted listing from the auction database 115. The remove item-wanted step 760 occurs when a fulfillment proposal supplies the exact number of items in an auction buyer's item-wanted listing.

The adjust units wanted step 770 reduces the number of items wanted in the auction buyer's item-wanted listing by the number of items offered in an auction seller's fulfillment proposal. The item-wanted listing remains in the auction database 115, but the number of items in the item-wanted listing is reduced.

FIG. 8 is a flow chart diagram illustrating one embodiment of an item-wanted search method 800 of the present invention. The item-wanted search method 800 includes a display search items wanted page step 810, a matching wanted items test 815, a display matching wanted items step 820, a display sell items page step 825, a receive sell item data step 830, an enter item record in database step 835. The item-wanted search method 800 facilitates an auction seller determining whether an auction buyer has posted an item-wanted listing for an item the auction seller has available for sale.

The display search items wanted page step 810 obtains search parameters from the auction seller specifying attributes of items wanted records to search for in the auction database 115. The parameters searched for may include immediate-purchase items, best-offer purchase items, time-dependent pricing items, new items, or used items.

The matching wanted items test 815 determines whether items wanted listings in the auction database 115 match the parameters provided by the auction seller. If the items wanted search parameters match any records in the auction database 115, the item-wanted search method 800 continues with the display matching wanted step 820, otherwise it continues with the display sell item page step 825.

The display matching wanted items step 820 displays the items wanted listings that match the search parameters provided by the auction seller. When the display matching wanted items step 820 is completed, the item-wanted search method 800 ends 840.

The display sell items page step 825 requests data from the auction seller concerning a sale item to be entered into the auction database 115. The display sell items page step 825 may obtain data using a data entry page, a form, a dialog, a wizard, or the like.

The receive sell item data step 830 obtains data from the auction seller corresponding to a sale item to be entered into the auction database 115. The receive sell item data step 830 may ask the auction seller to verify the accuracy of data entered.

The enter item record in database step 835 creates a new sale item record in the action database 115. The enter item record in database step 835 may generate an email message to notify the auction seller that a sale offer has been entered into the auction database 115 using the auction seller's account. When the enter item record in database step 835 is completed, the item-wanted search method 800 ends 840.

FIG. 8a is a flow chart diagram illustrating one embodiment of an auction item search method 850 of the present invention. The auction item search method 850 includes a display search sale items page step 860, a matching sale items test 865, a display matching sale items step 870, a display item-wanted page step 875, a receive item-wanted data step 880, and an enter item-wanted in database step 885.

The display search sale items page step 860 obtains search parameters from the auction buyer specifying attributes of sale item records to search for in the auction database 115. The parameters searched for may include immediate-sale items, best-offer sale items, time-dependent pricing items, new items, or used items.

The matching sale items test 865 determines whether items wanted listings in the auction database 115 match the parameters provided by the auction buyer. If the sale items search parameters match any records in the auction database 115, the auction item search method 850 continues with the display matching sale items step 870, otherwise it continues with the display item-wanted page step 875.

The display matching sale items step 870 displays the sale items listings that match the search parameters provided by the auction buyer. When the display matching sale items step 870 is completed, the item-wanted search method 800 ends 890.

The display item-wanted page step 875 requests data from the auction buyer concerning an item-wanted to be entered into the auction database 115. The display item-wanted page step 875 may obtain data using a data entry page, a form, a dialog, a wizard, or the like.

The receive item-wanted data step 880 obtains data from the auction buyer corresponding to a item-wanted to be entered into the auction database 115. The receive item-wanted data step 880 may ask the auction buyer to verify the accuracy of data entered.

The enter item-wanted in database step 885 creates a new item-wanted record in the action database 115. The enter item-wanted in database step 885 may generate an email message to notify the auction buyer that an item-wanted record has been entered into the auction database 115 using the auction buyer's account. When the enter item-wanted in database step 885 is completed, the item-wanted search method 800 ends 890.

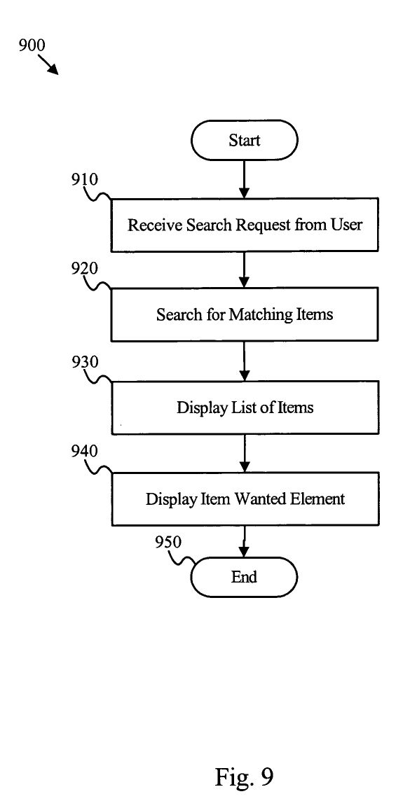

FIG. 9 is a flow chart diagram illustrating one embodiment of an item-wanted solicitation method 900 of the present invention. The item-wanted solicitation method 900 includes a receive search request step 910, a search items step 920, a display items step 930, and a display item-wanted element step 940. The item-wanted solicitation method 900 facilitates an auction buyer creating an item-wanted listing based on an existing sale item listing, item-wanted listing, or search results listing. For example, after a search of the auction database 115 returns search results including an 1879 Morgan silver dollar, an auction buyer may create an item-wanted listing for an 1880 Morgan silver dollar.

The receive search request step 910 obtains search parameters from the auction buyer specifying attributes of item records to search for in the auction database 115. The parameters searched for may include items wanted, immediate-sale items, best-offer sale items, time-dependent pricing items, new items, or used items. In another embodiment, the receive search request step 910 may comprise browsing records in the auction database 115 rather than searching.

The search items step 920 displays the item listings that match the search parameters provided by the auction buyer. The case where a search returns no matching items is not portrayed in the figure. In another embodiment, the search items step 920 comprises browsing records in the auction database 115 rather than searching.

The display items step 930 displays the item listings that match the search parameters provided by the auction buyer. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display item-wanted element step 940 provides an auction buyer with the option of listing an auction item-wanted listing by displaying a user interface element such as a control, dialog, icon, hyperlink, or the like. The item-wanted element may be linked to a data entry page, a form, a dialog, a wizard, or the like. The item-wanted element may give the auction buyer the option of creating a new item-wanted record or creating an item-wanted record based on an existing sale item listing, item-wanted listing, or search results listing. When the display item-wanted element step 940 is completed, the item-wanted solicitation method ends 950.

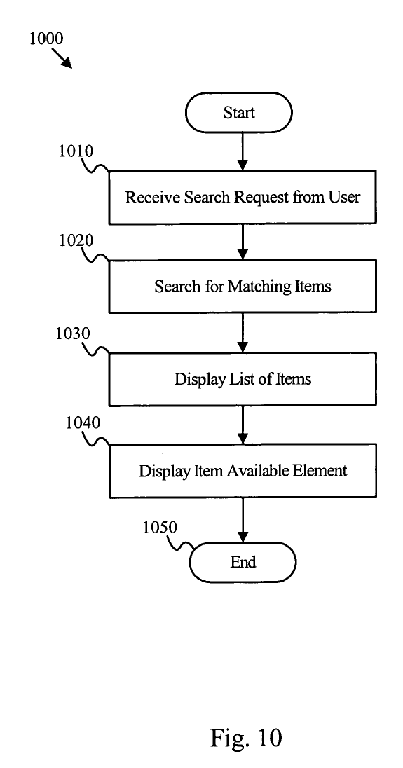

FIG. 10 is a flow chart diagram illustrating one embodiment of an item-available listing solicitation method 1000 of the present invention. The item-available listing solicitation method 1000 includes a receive search request step 1010, a search items step 1020, a display list step 1030, and a display item available element step 1040. The item available solicitation method 1000 facilitates an auction seller creating a sale item listing based on an existing sale item listing, item-wanted listing, or search results listing. For example, after a search of the auction database 1 15 returns search results including an item-wanted listing for an 1879 Morgan silver dollar, an auction seller may create a sale item listing for an 1880 Morgan silver dollar.

The receive search request step 1010 obtains search parameters from the auction seller specifying attributes of item records to search for in the auction database 115. The parameters searched for may include items wanted, immediate-sale items, best-offer sale items, time-dependent pricing items, new items, or used items. In another embodiment, the receive search request step 1010 may comprise browsing records in the auction database 115 rather than searching.

The search items step 1020 displays the item listings that match the search parameters provided by the auction seller. The case where a search returns no matching items is not portrayed in the figure. In another embodiment, the search items step 1020 comprises browsing records in the auction database 115 rather than searching.

The display list step 1030 displays the item listings that match the search parameters provided by the auction buyer. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display item available element step 1040 provides an auction seller with the option of listing a sale item listing by displaying a user interface element such as a control, dialog, icon, hyperlink, or the like. The item available element may be linked to a data entry page, a form, a dialog, a wizard, or the like. The item available element may give the auction seller the option of creating a new sale item record or creating a sale item record based on an existing sale item listing, item-wanted listing, or search results listing. When the display item available element step 1040 is completed, the item-wanted solicitation method ends 1050.

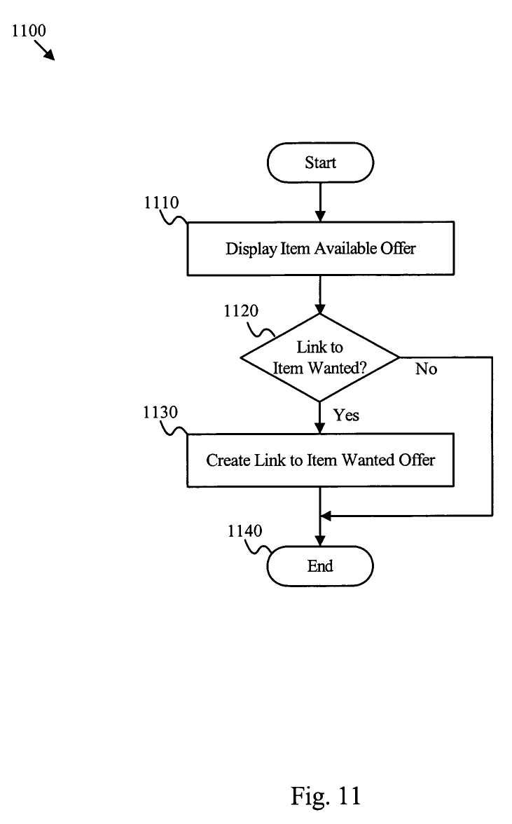

FIG. 11 is a flow chart diagram illustrating one embodiment of an item-available to item-wanted link method 1100 of the present invention. The item-available to item-wanted link method 1100 includes a display item available offer step 1110, a link to item-wanted test 1120, and a create link step 1 130. The item-available to item-wanted link method 1100 establishes a relationship between a sale item record and an item-wanted record in the auction database 115. The relationship may be established by an auction trader or a database process.

The display item available offer step 1110 displays a sale item record in the auction database 115. In some embodiments, the display item available offer step 1110 may provide the results of a search of the auction database 115 to a linking process.

The link to item-wanted test 1120 determines whether an auction trader or linking process is to establish a relationship between the sale item record displayed by the display item available offer step 1110 and an item-wanted record. If the auction trader or linking process is to establish a relationship, the item-available to item-wanted link method 1100 continues with the create link step 1130, otherwise the item-available to item-wanted link method 1100 ends 1140.

The create link step 1130 creates a relationship between the sale item displayed by the display item available offer step 1110 and the item-wanted record. The create link step 1130 may display a link to an item-wanted listing proximate to the sale item listing. After the create link step 1130 is completed, the item-available to item-wanted link method 1100 ends 1140.

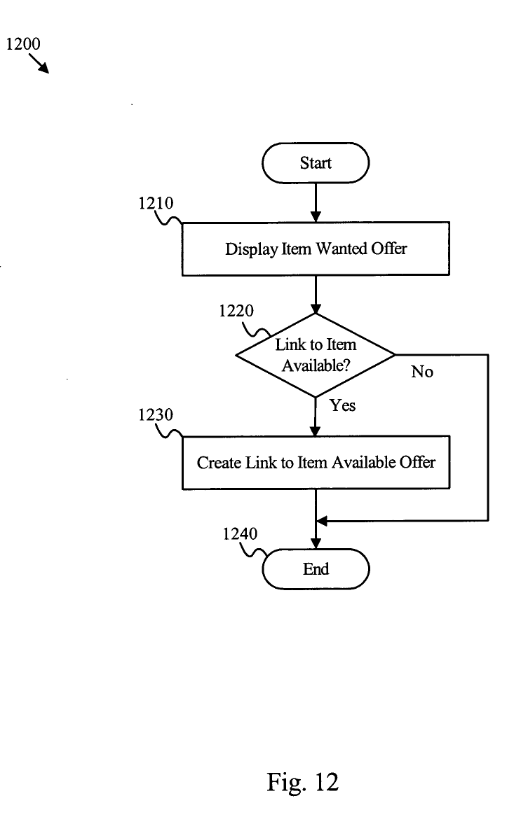

FIG. 12 is a flow chart diagram illustrating one embodiment of an item-wanted to item-available link method 1200 of the present invention. The item-wanted to item-available link method 1200 includes a display offer step 1210, a link to item available test 1220, and a display link step 1230. The item-wanted to item-available link method 1200 establishes a relationship between an item-wanted record and a sale item record in the auction database 115. The relationship may be established by an auction trader or a database process.

The display offer step 1210 displays an item-wanted record in the auction database 115. In some embodiments, the display item-wanted offer step 1210 may provide the results of a search of the auction database 115 to a linking process.

The link to item available test 1220 determines whether an auction trader or linking process is to establish a relationship between the item-wanted record displayed by the display offer step 1210 and a sale item record. If the auction trader or linking process is to establish a relationship, the item-wanted to item-available link method 1200 continues with the create link step 1230, otherwise the item-wanted to item-available link method 1200 ends 1240.

The create link step 1230 creates a relationship between the item-wanted displayed by the display offer step 1210 and the sale item record. The create link step 1230 may display a link to a sale item listing proximate to the item-wanted listing. After the create link step 1230 is completed, the item-wanted to item-available link method 1200 ends 1240.

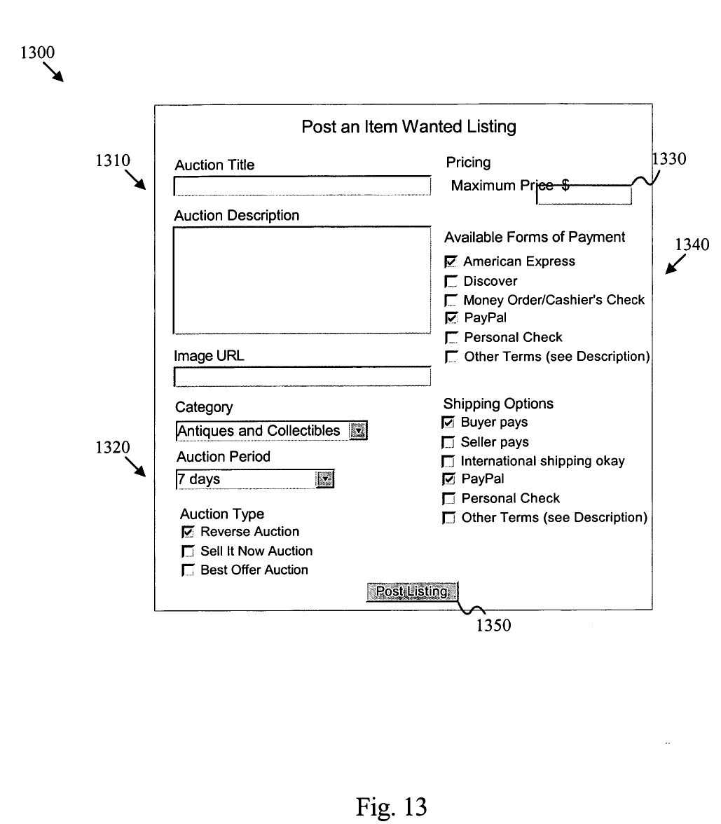

FIG. 13 is a block diagram illustrating one embodiment of an item-wanted listing dialog 1300 of the present invention. The item-wanted listing dialog 1300 includes auction description fields 1310, auction parameters elements 1320, a pricing element 1330, payment and shipping option elements 1340, and a post item control 1350. The item-wanted listing dialog 1300 facilitates auction traders listing item-wanted listings in the auction database 115.

Auction description fields 1310 receive information describing the item the auction buyer would like to purchase. Typical fields include an auction title, a description of the item-wanted, a URL for the location of an image file containing a picture of the item-wanted, and a category for the item-wanted listing.

Auction parameters elements 1320 allow the auction seller to specify information about the auction. Typical fields in the auction parameters elements 1320 include the length of the auction, and a definition of the auction type, reverse-auction, sell now auction, best-offer auction, or the like.

The pricing element 1330 allows the auction seller to specify the maximum price the seller is willing to pay for the item-wanted. In one embodiment, the pricing element 1330 consists of a text field where the auction buyer may enter a description of items the buyer is willing to accept in trade.

Payment and shipping option elements 1340 facilitate the auction buyer specifying what methods of payment the buyer has available for payment and acceptable methods of shipping. In one embodiment, payment and shipping option elements 1340 include separate shipping options for domestic and international shipping.

The post item control 1350 accepts the data entered by the auction buyer for entry into the auction database 115. In one embodiment, the item-wanted listing dialog 1300 includes a method for validating data entered by the auction buyer before the data is transmitted to the auction database 115. The method may be a Per1 script, Java applet, Javascript program, Python program or the like.

The present invention facilitates online auction trading. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for facilitating online commerce, the method comprising:
displaying hierarchical listings corresponding to a product line;
receiving an item-wanted posting from a user;
storing the item-wanted posting in a data store; and
adding an item-wanted listing corresponding to the item-wanted posting to the hierarchical listings.

2. The method of claim 1, further comprising adding an item-available listing to the hierarchical listings.

3. The method of claim 1, wherein the item-wanted posting is associated with time-dependent pricing.

4. The method of claim 1, wherein the item-wanted posting corresponds to a new item.

5. The method of claim 1, wherein the item-wanted posting corresponds to a used-item.

6. The method of claim 1, wherein the item-wanted listing is displayed anonymously.

7. The method of claim 1, further comprising receiving a fulfillment proposal from a providing party.

8. The method of claim 7, further comprising removing selected item-wanted postings from the database in response to a fulfillment proposal.

9. The method of claim 7, wherein the selected item-wanted postings have an average cleared price greater than an average fulfillment cost.

10. The method of claim 7, wherein the selected item-wanted postings have a total unit count less than or equal to a proposed fulfillment count.

11. The method of claim 7, further comprising adding an item-available posting to the database in response to a fulfillment surplus.

12. A method for facilitating online commerce, the method comprising:
receiving search parameters from a user; and
providing an option to post an item-wanted posting having at least one attribute corresponding to a search parameter.

13. The method of claim 12, wherein the item-wanted posting is associated with time-dependent pricing.

14. A method for facilitating online commerce, the method comprising:
displaying a plurality of listings corresponding to items available for online commerce; and
providing an option to post an item-wanted posting having a description corresponding to a selected listing.

15. The method of claim 14, wherein the list of items comprises available items.

16. The method of claim 14, wherein the list of items comprises wanted items.

17. The method of claim 14, wherein the list of items comprises search results.

18. The method of claim 14, wherein the item-wanted listing includes time-dependent pricing.

19. A method for facilitating online commerce, the method comprising:
displaying a plurality of listings corresponding to items available for online commerce; and
providing an option to post an item-available posting having a description corresponding to a selected listing.

20. The method of claim 19, wherein the list of items comprises available items.

21. The method of claim 19, wherein the list of items comprises wanted items.

22. The method of claim 19, wherein the list of items comprises search results.

23. The method of claim 19, wherein the item-available listing includes time-dependent pricing.

24. A method for facilitating online commerce, the method comprising:
displaying a plurality of listings corresponding to items available for online commerce including an item-available listing; and
displaying a link to an item-wanted listing proximate to the item-available listing.

25. The method of claim 24, wherein the link is established by an item-wanted party.

26. The method of claim 24, wherein the link is established by an item-available party.

27. The method of claim 24, wherein the link is established by a user.

28. The method of claim 24, wherein the link is established by a linking process.

29. The method of claim 24, wherein displaying the link is viewer-dependent.

30. A method for facilitating online commerce, the method comprising:
displaying a plurality of listings corresponding to items available for online commerce including an item-wanted listing; and
displaying a link to an item-available listing proximate to the item-wanted listing.

31. The method of claim 30, wherein the link is established by an item-wanted party.

32. The method of claim 30, wherein the link is established by an item-available party.

33. The method of claim 30, wherein the link is established by a user.

34. The method of claim 30, wherein the link is established by a linking process.

35. The method of claim 30, wherein displaying the link is viewer-dependent.
